(19) United States
(12) Patent Application Publication
(10) Pub. No.: US 2016/0313987 A1
(43) Pub. Date: Oct. 27, 2016

(54) METHOD AND SYSTEM FOR UPDATING SOFTWARE

(71) Applicant: SAMSUNG ELECTRONICS CO., LTD., Suwon-Si (KR)

(72) Inventors: SUNG-HOON SON, SUWON-SI (KR); KI-HYOUN KWON, HWASEONG-SI (KR); SEUNG-HO LEE, HWASEONG-SI (KR); JUN-HO LEE, HWASEONG-SI (KR); JEROME HAN, YUSEONG-GU (KR)

(21) Appl. No.: 15/097,303

(22) Filed: Apr. 13, 2016

(30) Foreign Application Priority Data
Apr. 27, 2015 (KR) 10-2015-0058930

(51) Int. Cl. G06F 9/445

(52) U.S. Cl. CPC G06F 8/65

(57) ABSTRACT

A method for updating software includes verifying an update for first software that drives a security execution environment in a non-security execution environment, updating the first software by use of a first image of the first software update stored in the non-security execution environment, verifying an update for second software that drives a security device controlled by the security execution environment, in the security execution environment, and updating the second software by use of a second image of the second software update stored in the security execution environment.

### CROSS-REFERENCE TO RELATED APPLICATION

This application claims priority from Korean Patent Application No. 10-2015-0058930 filed on Apr. 27, 2015 in the Korean Intellectual Property Office, the disclosure of which is incorporated herein by reference in its entirety.

### BACKGROUND

1. Field of the Disclosure

The present disclosure relates to a method and a system for updating software.

2. Description of the Related Art

In a computing device including a mobile device, it is possible to use security mechanisms using a platform that includes a rich execution environment (REE) and a trusted execution environment (TEE). The rich execution environment includes a non-security execution environment, and the trusted execution environment includes a security execution environment that provides exclusive access to data or hardware requiring the security. For example, one or more processors can host both REE and TEE, the TEE is isolated from the REE, and the processor ensures that some operations can be executed only in the TEE. In order to ensure the reliability of the security mechanism, the software (e.g., firmware) installed in a security element (SE) controlled by the TEE and the TEE should not be forged or falsified.

### SUMMARY

An aspect of the present disclosure provides a method for safely updating software that controls TEE and SE.

Another aspect of the present disclosure provides a system for updating software for securely updating the software that controls TEE and SE, and a computer-readable recording medium.

The aspects of the present disclosure are not limited to the above-mentioned technical problems, and other aspects that have not been mentioned will be clearly understood by those skilled in the art from the following description.

According to an aspect of the present disclosure, there is provided a method for updating software. The method includes verifying, with a processor and a first update manager that operates in a non-security execution environment, an update for first software that drives a security execution environment in a non-security execution environment; updating, with the first update manager, the first software by use of a first image of the first software update, which is stored in the non-security execution environment; verifying, with the processor and a second update manager that operates in the security execution environment, an update for second software that drives a security device controlled by the security execution environment, in the security execution environment; and updating, with the second update manager, the second software by use of a second image of the second software update, which is stored in the security execution environment. The verifying the updates for the first and second software includes verifying the correct software versions or capabilities of the first and second software updates.

According to another aspect of the present disclosure, there is provided a method for updating software. The method includes storing, with an image manager, image data in a non-security execution environment, the image data including a first image of an update for first software that drives a security execution environment, and a second image of an update for second software that drives a security device controlled by the security execution environment; updating, with a first update manager that operates in the non-security execution environment, the first software in the non-security execution environment by use of the first image of the image data; extracting the second image included in the image data to store, with the image manager, the second image in the security execution environment; and updating, with a second update manager that operates in the security execution environment, the second software in the security execution environment by use of the second image stored in the security execution environment.

According to an aspect of the present disclosure, there is provided a system for updating software. The system includes a processor; a first update manager that operates in a non-security execution environment; and a second update manager which operates in a security execution environment. The first update manager verifies an update for first software that drives the security execution environment by use of the processor and updates the first software by use of a first image of the first software update stored in the non-secure execution environment. The second update manager verifies an update for second software that drives a security device controlled by the security execution environment by use of the processor and updates the second software by use of a second image of the second software update stored in the security execution environment. The verifying the updates for the first and second software includes verifying the correct software versions or capabilities of the first and second software updates.

According to an aspect of the present disclosure, there is provided a non-transitory computer-readable recording medium that stores one or more instruction words which cause a computer to execute a method of verifying an update for software by use of a processor. The method includes driving a second execution environment in a first execution environment, and causing the computer to update the software by use of an image of the software update stored in the first execution environment.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic diagram for explaining a system for updating software according to an embodiment of the present disclosure;

FIG. 2 is a schematic diagram for explaining an update manager of the system for updating software according to an embodiment of the present disclosure;

FIG. 3 is a schematic diagram for explaining a structure of image data according to an embodiment of the present disclosure;

FIG. 4 is a schematic diagram for explaining a method for updating software according to an embodiment of the present disclosure;

FIG. 5 is a schematic diagram for explaining a structure of image data according to another embodiment of the present disclosure;

FIG. 6 is a schematic diagram for explaining a method for updating software according to another embodiment of the present disclosure;

FIG. 7 is a schematic diagram for explaining a structure of image data according to still another embodiment of the present disclosure;

FIG. 8 is a schematic diagram for explaining a method for updating software according to still another embodiment of the present disclosure;

FIG. 9 is a schematic diagram for explaining a structure of image data according to still another embodiment of the present disclosure;

FIG. 10 is a schematic diagram for explaining a method for updating software according to still another embodiment of the present disclosure;

FIG. 11 is a flowchart for explaining the method for updating software according to an embodiment of the present disclosure.

FIG. 12 is a flowchart for explaining the method for updating software according to an embodiment of the present disclosure;

FIG. 13 is a flowchart for explaining the method for updating software according to an embodiment of the present disclosure; and

FIGS. 14 to 16 are exemplary semiconductor systems to which the method and system for updating software according to the embodiments of the present disclosure are applicable.

### DETAILED DESCRIPTION OF THE EMBODIMENTS

Embodiments will be described in detail with reference to the accompanying drawings. The disclosure, however, may be embodied in various different forms, and should not be construed as being limited only to the illustrated embodiments. Rather, these embodiments are provided as examples so that this disclosure will be thorough and complete, and will fully convey the concept of the disclosure to those skilled in the art. Accordingly, known processes, elements, and techniques are not described with respect to some of the embodiments of the disclosure. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the disclosure.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

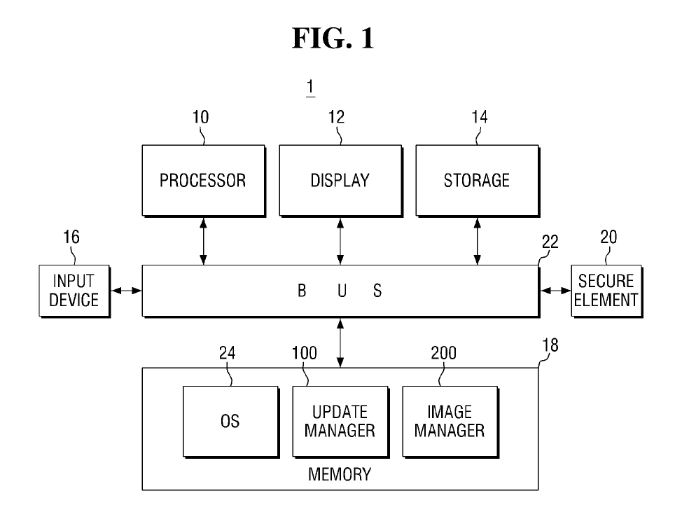

FIG. 1 is a schematic diagram for explaining a system for updating software according to an embodiment of the present disclosure.

Referring to FIG. 1, a system 1 for updating software according to an embodiment of the present disclosure includes a processor 10, a display 12, a storage 14, an input device 16, a memory 18 and a security element (SE) 20. The processor 10, the display 12, the storage 14, the input device 16, the memory 18 and the SE 20 are electrically connected together through a bus 22 to be able to transmit data to and receive data from one another.

In various embodiments of the present disclosure, the memory 18 can include an operating system 24, an update manager 100 and an image manager 200. Here, the operating system 24 can include a non-security kernel 216 that operates in a non-security execution environment 210, and a security kernel 226 that operates in a security execution environment 220.

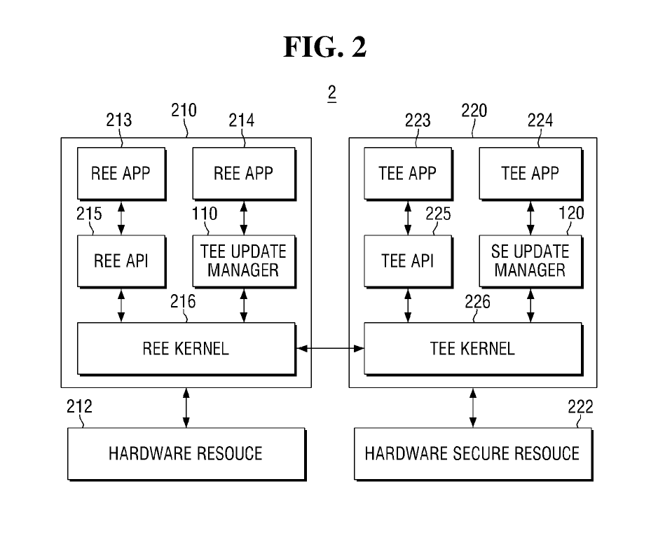

The update manager 100 updates software for driving the security execution environment 220 by use of an image stored in the non-security execution environment 210, and updates software for driving the security element 20 by use of an image stored in the security execution environment 220. Here, the image can mean a “software image” that includes data of software or an operating system capable of driving various types of semiconductor devices, for example, a computing system, a mobile device, a security hardware and a device controller. The update manager 100 includes a first update manager 110 that operates in the non-security execution environment 210, and a second update manager 120 that operates in the security execution environment 220. The specific description of the first update manager 110 and the second update manager 120 will be described later with reference to FIG. 2.

The image manager 200 can store the software images used to update the software for driving the security execution environment 220 or the software for driving the security element 20 in the non-security execution environment 210 or in the security execution environment 220, or can decode the encoded software.

In some embodiments of the present disclosure, the update manager 100 and the image manager 200 can be implemented as a software program and loaded in the memory 18 or can be executed on the processor 10. However, the scope of the present disclosure is not limited thereto, and in some embodiments of the present disclosure, the update manager 100 and the image manager 200 may be implemented as hardware such as a chip including an electronic circuit.

FIG. 2 is a schematic diagram for explaining an update manager of a system for updating software according to an embodiment of the present disclosure.

Referring to FIG. 2, a system 2 for updating software according to an embodiment of the present disclosure includes a non-security execution environment 210 and a security execution environment 220. In some embodiments of the present disclosure, the non-security execution environment 210 can include a rich execution environment (REE), and the security execution environment 220 can include a trusted execution environment (TEE).

The non-security execution environment 210 can include a first update manager (TEE update manager) 110, non-security applications 213, 214, a non-security API (Application Programming Interface) 215 and a non-security kernel 216.

The first update manager 110 operates in the non-security execution environment 210, and verifies an update for first software that drives the security execution environment 220. In some embodiments of the present disclosure, the first update manager 110 can verify at least one of a binary hash, software version information of the security execution environment 220, and software version information of the first software update. Further, the first update manager 110 updates the first software, using a first image of the first software update that is stored in the non-security execution environment 210. In some embodiments of the present disclosure, the first software update may be stored in the non-security execution environment 210 by the image manager 200, before the first update manager 110 verifies the first software update. Meanwhile, in some embodiments of the present disclosure, the first software can include firmware or an application that drives the security execution environment 220.

The non-security applications 213, 214 perform the operations or functions that are not secured. The non-security applications 213, 214, for example, can include a preload application, a native application or the like, but the scope of the present disclosure is not limited thereto.

The non-security API 215 provides an interface or a function which enables the non-security applications 213, 214 to control the functions provided by the non-security kernel 216. For example, the non-security API 215 enables the non-security applications 213, 214 to exchange data with the non-security kernel 216 or enables the non-security applications 213, 214 to use the hardware resource 212 managed by the non-security kernel 216.

The non-security kernel 216 can control or manage the hardware resource 212 used to execute the operations or functions embodied in the non-security applications 213, 214 or the non-security API 215. In particular, the non-security kernel 216 can include a driver (e.g., a monitor) for performing the communication with the security kernel 226. The non-security execution environment 210 can require the security execution environment 220 to perform certain security operations or functions, using the driver.

Meanwhile, the security execution environment 220 can include a second update manager (a SE update manager) 120, security applications 223, 224, a security API 225 and a security kernel 226.

The second update manager 120 operates in the security execution environment 220, and verifies an update for second software that drives the security device controlled by the security execution environment 220. Here, the security device, for example, can include a security element 20. In some embodiments of the present disclosure, the second update manager 120 can verify the software version information of the security device or software version information of the second software update. Further, the second update manager 120 updates the second software, using the second image of the second software update stored in the security execution environment 220. In some embodiments of the present disclosure, the second software update together with the first image may be stored in the non-security execution environment 210 by the image manager 200, before the first update manager 110 verifies the first software update. Meanwhile, in some embodiments of the present disclosure, the second software can include firmware or an application that drives the security device controlled by the security execution environment 220.

The security applications 223, 224, for example, perform the secured operation or function in response to a request of the non-security execution environment 210. The security applications 223, 224, for example, can include a preload application, a native application or the like, but the scope of the present disclosure is not limited thereto. In particular, in some embodiments of the present disclosure, the security application 224 is capable of transmitting and receiving data to and from the security element (SE) 20.

The security API 225 provides an interface or function that enables the security applications 223, 224 to control the functions provided by the security kernel 226. For example, the security API 225 can enable the security applications 223, 224 to exchange data with the security kernel 226 or can enable the security applications 223, 224 to use the hardware security resources 222 managed by the non-security kernel 226.

The security kernel 226 can control or manage the hardware security resource 222 used to perform operations or functions embodied in the security applications 223, 224 or the security API 225.

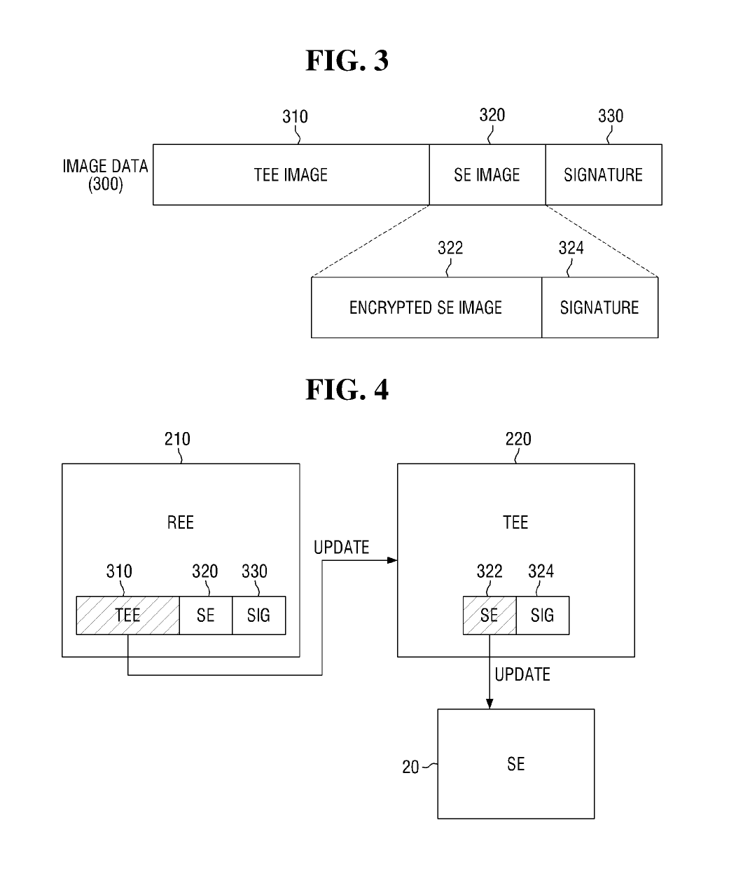

FIG. 3 is a schematic diagram for explaining the structure of image data according to an embodiment of the present disclosure.

Referring to FIG. 3, image data 300 according to an embodiment of the present disclosure includes a TEE image 310, an SE image 320 and a signature 330. Here, the TEE image 310 includes an image of a first software update that drives the security execution environment 220, and the SE image 320 includes an image of a second software update that drives the security element 20 controlled by the security execution environment 220.

In this embodiment, the SE image 320 included in the image data 300 can include an encoded SE image 322 and a signature 324. That is, after the image manager 200 generates the image data 300 that includes the TEE image 310 and the encoded SE image 322, the image manager 200 can store the image data 300 in the non-security execution environment 210. Here, the TEE image 310 can be an image that is not encoded, but the scope of the present disclosure is not limited thereto.

Meanwhile, the signatures 330, 324 can include data for determining whether the software update is forged or falsified prior to updating the software. For example, the verification of the signature 330 for updating the first software can include verification of the signature 330 using a public key of the application processor (AP) stored in the non-security execution region 210. Meanwhile, the verification of the signature 324 for updating the second software can include verification of the signature 324 using a public key of the application processor (AP) stored in the security execution region 220.

FIG. 4 is a schematic diagram for explaining a method for updating software according to an embodiment of the present disclosure.

Referring to FIG. 4, the first update manager 110 verifies the update for the first software that drives the security execution environment 220. That is, the first software update verifying work of the first update manager 110 can be performed in the non-security execution environment 210. In some embodiments of the present disclosure, the first update manager 110 can verify at least one of a binary hash, software version information of the security execution environment 220, and software version information of the first software update.

As a result of verification of the first software update, when it is determined that there is a need to update the first software, the first update manager 110 updates the first software, using the first image of the first software update in the image data 300 stored in the non-security execution environment 210, that is, the TEE image 310. Here, the case where there is a need to update the first software can include a case where the first software is forged or falsified and its reliability is suspected, a case where compatibility of the version of the first software with older versions or other devices is not guaranteed, and a case where there is a request for updating the first software from a user application or a system application.

After the updating work of the first software, the encoded SE image 322 and the signature 324 in the image data 300 stored in the non-security execution environment 210 can be stored in the security execution environment 220, by at least one of the image manager 200, the first update manager 110 and the second update manager 120. Thus, the non-security execution environment 210 is not able to access the encoded SE image 322 and the signature 324 stored in the security execution environment 220.

In some embodiments of the present disclosure, the updating of the first software using the TEE image 310 stored in the non-security execution environment 210 can further include the backup of an image of the first software in the security execution environment 220, prior to updating the first software. Thus, when the updating of the first software fails, it is possible to perform rollback of the first software, using the image of the first software that is backed up in the security execution environment 220.

Referring to FIG. 4, the second update manager 120 verifies the update for the second software that drives the security element 20 controlled by the security execution environment 220. That is, the second software update verifying work of the second update manager 120 is performed in the security execution environment 210. In some embodiments of the present disclosure, the second update manager 120 can verify the software version information of the security element 20 or software version information of the second software update.

As a result of verification of the second software update, when it is determined that there is a need to update the second software, the second update manager 120 updates the second software, using a second image stored in the security execution environment 220, that is, the encoded SE image 322. Here, the case where there is a need to update the second software can include a case where the second software is forged or falsified and its reliability is suspected, a case where compatibility of the version of the second software with older versions or other devices is not guaranteed, and a case where there is a request for updating the second software from a user application or a system application.

Here, the encoded SE image 322 can be decoded, prior to updating the second software. In some embodiments of the present disclosure, after the encoded SE image 322 is decoded in the security execution environment 220, it can be used to update the second software. Meanwhile, in some other embodiments of the present disclosure, after the encoded SE image 322 is transmitted to the security element 20 from the security execution environment 220 and is decoded in the security element 220, it can be used to update the second software.

In some embodiments of the present disclosure, the updating of the second software using the encoded SE image 322 stored in the security execution environment 220 can further include backup of the image of the second software in the security execution environment 220 or the security element 20, prior to updating the second software. Thus, when the updating of the second software fails, it is possible to perform rollback of the second software, using the image of the second software backed-up in the security execution environment 220 or the security element 20.

In some embodiments of the present disclosure, the verifying and updating works can be performed when booting the system 1 for updating software. Specifically, after the booting of the system 1 for updating software is started and the first update manager 110 and the second update manager 120 perform the verifying of the first software update and second software update and the updating work of the first software and the second software, the booting of the system 1 for updating software can be completed. Meanwhile, in some embodiments of the present disclosure, the verifying of the first software update and second software update and the updating work of the first software and the second software may be performed at the time of start of the user application or the system application requested to update the first software and the second software. Verifying the software update may include checking the software version or capabilities of the software. Accordingly, verifying the first and second software updates may include checking the software versions or capabilities of the first and second software updates.

According to the method for updating software of the present disclosure as described above, since a software image of the security element 20, for example, a binary image of the firmware for driving the security element 20 is not exposed to the outside, including the secure execution environment 210, it is possible to update the software of the security element 20 in a secure manner Meanwhile, since the method for updating software of the present disclosure sequentially updates the first software and the second software, by the use of one image data that includes a first image used to update the first software and a second image used to update the second software that controls the execution environment or the device driven by the first software, it is possible to easily update a plurality of pieces of software that drive a plurality of execution environments or devices, and when problems of software occur, it is also possible to easily recover from the problems.

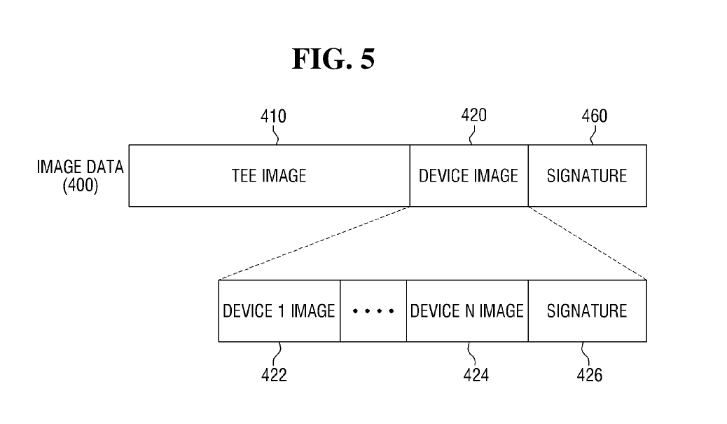

FIG. 5 is a schematic diagram for explaining a structure of image data according to another embodiment of the present disclosure.

Referring to FIG. 5, image data 400 according to another embodiment of the present disclosure includes a TEE image 410, a device image 420 and a signature 460. Here, the TEE image 410 includes an image of an update for first software that drives the security execution environment 220, and the device image 420 includes images of one or more updates for second software that drive one or more device 230, 232 controlled by the security execution environment 220.

In this embodiment, the device image 420 included in the image data 400 can include one or more device images 422, 424 and a signature 426. In some embodiments of the present disclosure, one or more device images 422, 424 can be encoded images.

Meanwhile, the signatures 460, 426 can include data for determining whether the software update is forged or falsified prior to updating the software. For example, the signature 460 can be used in the verification for updating the first software, and the signature 426 can be commonly used in the verification for updating one or more second software of one or more devices 230, 232, respectively.

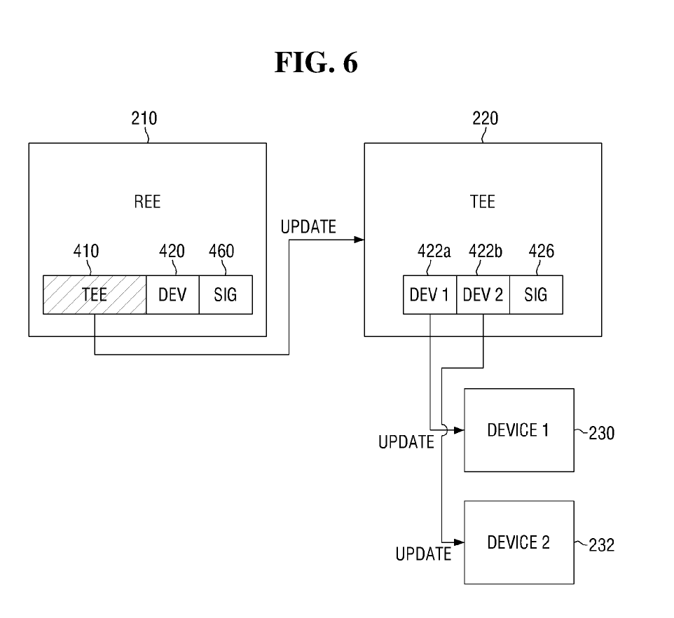

FIG. 6 is a schematic diagram for explaining a method for updating software according to another embodiment of the present disclosure.

Referring to FIG. 6, the first update manager 110 verifies the update for the first software that drives the security execution environment 220. That is, the first software update verifying work of the first update manager 110 can be performed in the non-security execution environment 210.

As a result of verification of the first software update, when it is determined that there is need to update the first software, the first update manager 110 updates the first software, using the first image of the first software update in the image data 410 stored in the non-security execution environment 210, that is, the TEE image 410. Here, the case where there is a need to update the first software can include a case where the first software is forged or falsified and its reliability is suspected, a case where compatibility of the version of the first software with older versions or other devices is not guaranteed, and a case where there is a request for updating the first software from a user application or a system application.

After the updating work of the first software, the device images 422a, 422b and the signature 426 in the image data 400 stored in the non-security execution environment 210 can be stored in the security execution environment 220, by at least one of the image manager 200, the first update manager 110 and the second update manager 120. Thus, the non-security execution environment 210 is not able to access the device images 422a, 422b and the signature 426 stored in the security execution environment 220. In some embodiments of the present disclosure, the device images 422a, 422b may be encoded.

Referring to FIG. 6, the second update manager 120 verifies one or more updates for the second software that drives one or more devices 230, 232 controlled by the security execution environment 220. That is, the second software update verifying work of the second update manager 120 is performed in the security execution environment 210. In some embodiments of the present disclosure, the second update manager 120 can verify each software version information of the devices 230, 232 or software version information of the second software update.

As a result of verification of the second software update, when it is determined that there is need to update the second software, the second update manager 120 updates the second software, using the second image stored in the security execution environment 220, that is, the device images 422a, 422b. Specifically, the second update manager 120 updates the second software that drives the first device 230 by the use of the device image 422a, and updates the second software that drives the second device 232 by the use of the image device 422b. Here, the case where there is a need to update the second software can include a case where the second software is forged or falsified and its reliability is suspected, a case where compatibility of the version of the second software with older versions or other devices is not guaranteed, and a case where there is a request for updating the second software from a user application or a system application.

Here, when the device images 422a, 422b are encoded, the encoded device images 422a, 422b can be decoded prior to updating the second software. In some embodiments of the present disclosure, after the encoded image device 422a, 422b are decoded in the security execution environment 220, the images can be used to update the second software. Meanwhile, in some other embodiments of the present disclosure, after the encoded device images 422a, 422b are transmitted from the security execution environment 220 to the device 230, 232 and are decoded in the devices 230, 232, the images can be used to update the second software.

According to the method for updating software of the present disclosure as described above, since the software images of the plurality of devices 230, 232, for example, the binary images of the firmware for driving each of the plurality of devices 230, 232 are not exposed to the outside, including the non-security execution environment 210, it is possible to update software of the plurality device 230, 232 in a secure manner. Meanwhile, according to the method for updating software of the present disclosure, the first software and the second software are sequentially updated, by the use of one image data that includes the first image used to update the first software and the second image used to update the second software that controls the execution environment or the device driven by the first software, and in particular, the software for driving the plurality of devices 230, 232 is consecutively updated. Accordingly, it is possible to easily and efficiently update a plurality of pieces of software that drive a plurality of execution environments or devices, and when problems of software of the plurality of devices 230, 232 occur, it is also possible to easily and efficiently recover from the problems.

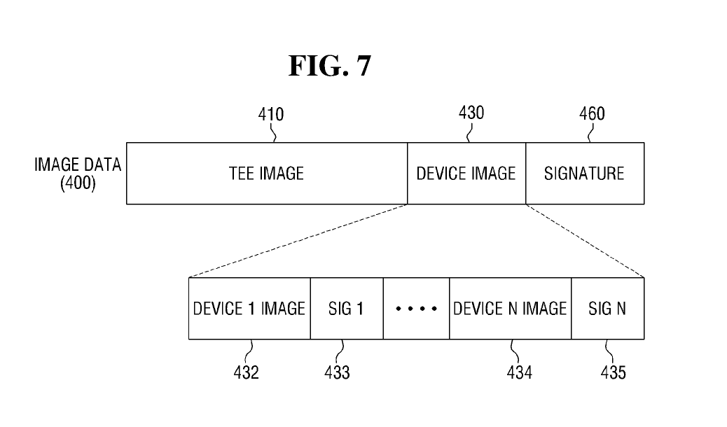

FIG. 7 is a schematic diagram for explaining a structure of image data according to another embodiment of the present disclosure.

Referring to FIG. 7, this embodiment differs from the embodiment related to FIG. 5 in that image data 400 according to still another embodiment of the present disclosure includes a TEE image 410, a device image 430 and a signature 460, and the device image 430 stores images of one or more second software updates that drive one or more devices 230, 232 controlled by the security execution environment 220.

Specifically, in this embodiment, the device image 430 included in the image data 400 can include a first device image 432, a first signature 433, . . . , and an N-th device image 434 and an N-th signature 435 (where, N is a natural number). In some embodiments of the present disclosure, one or more device images 432, 434 may be encoded images. The first signature 433 can be used in the verification for updating the second software in the first device, and the N-th signature 435 can be used in the verification for updating the second software in the N-th device.

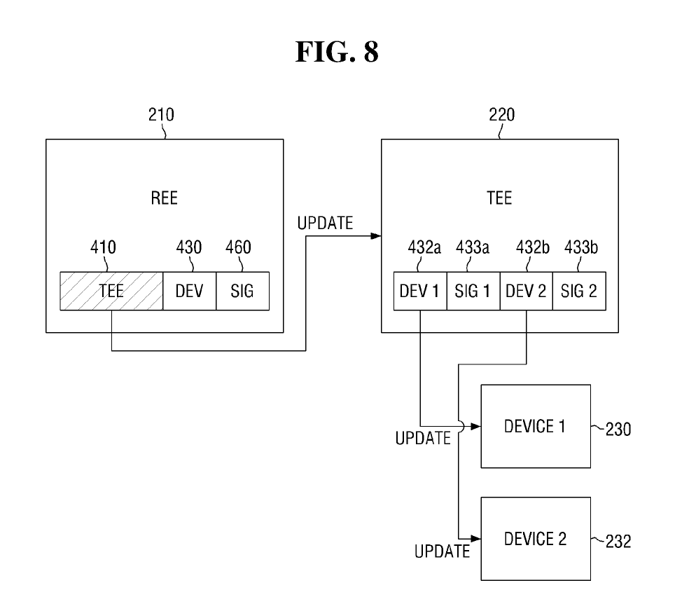

FIG. 8 is a schematic diagram for explaining a method for updating software according to still another embodiment of the present disclosure.

Referring to FIG. 8, this embodiment differs from the embodiment related to FIG. 6 in that, after the updating work of the first software, the device images 432a, 432b and the signatures 433a, 433b in the image data 400 stored in the non-security execution environment 210 are stored in the security execution environment 220 by at least one of the image manager 200, the first update manager 110 and the second update manager 120.

Thus, when there is a need to update the second software, the second update manager 120 updates the second software for driving the first device 230 by the use of the first device image 432a and the first signature 433a, and updates the second software for driving the second device 232, by the use of the second device image 432b and the second signature 433b.

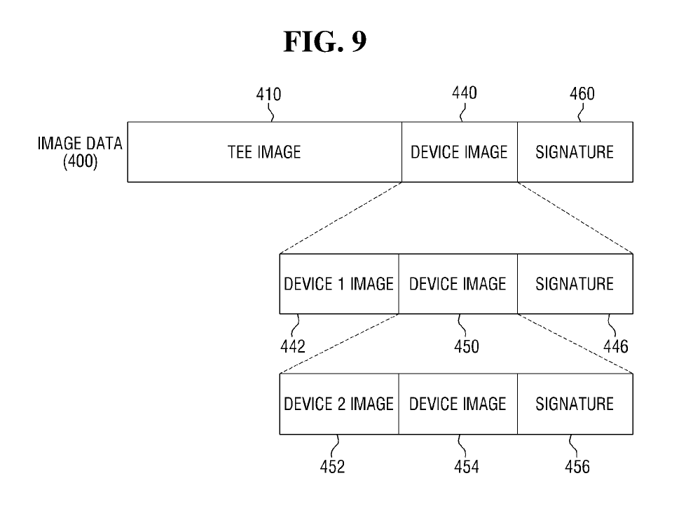

FIG. 9 is a schematic diagram for explaining a structure of image data according to still another embodiment of the present disclosure.

Referring to FIG. 9, this embodiment differs from the embodiment related to FIG. 7 in that image data 400 according to still another embodiment of the present disclosure includes a TEE image 410, a device image 440 and a signature 460, and the device image 440 includes a first device image 442 controlled by the security execution environment 220, a remaining device image 450 and a first signature 446. Also, the device image 450 includes a second device image 452 controlled by the security execution environment 220, a remaining device image 454 and a second signature 456.

In some embodiments of the present disclosure, one or more device images 442, 452 can be encoded images. The first signature 446 can be used in the verification for updating the second software in the first device, and the second signature 456 can be used in the verification for updating the second software in the N-th device.

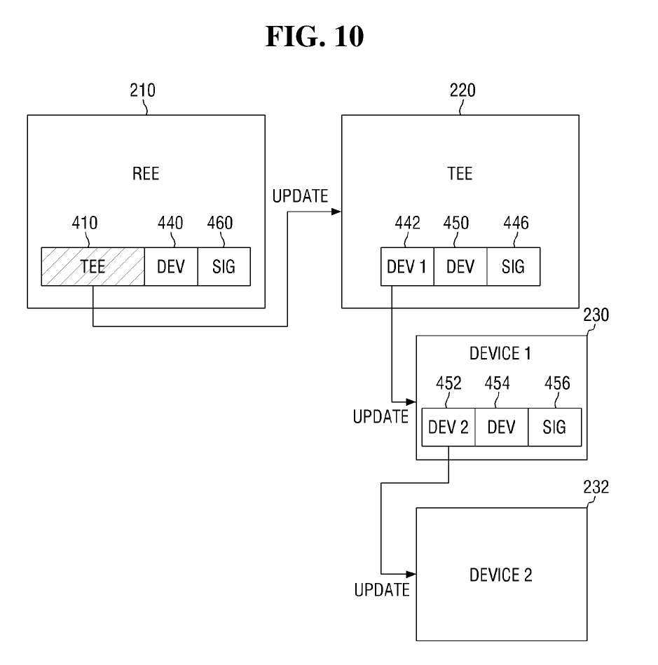

FIG. 10 is a schematic diagram for explaining a method for updating software according to still another embodiment of the present disclosure.

Referring to FIG. 10, this embodiment differs from the embodiment of FIG. 8 in that, after the updating work of the first software, the first device image 442, the remaining device image 450 and the first signature 446 in the image data 400 stored in the non-security execution environment 210 are stored in the security execution environment 220, by at least one of the image manager 200, the first update manager 110 and the second update manager 120, and while performing the updating work of the first device 230, the second device image 452, the remaining device image 454 and the second signature 456 are stored in the first device 230, by at least one of the image manager 200 and the second update manager 120.

Thus, when there is a need to update the second software, the second update manager 120 updates the second software for driving the first device 230 by the use of the first device image 442 and the first signature 446 stored in the security execution environment 220, and updates the second software for driving the second device 232 by the use of the second device image 452 and the second signature 456 stored in the first device 230. Of course, the remaining device image 454 stored in the first device 230 can be transmitted to the second device 232 and stored therein.

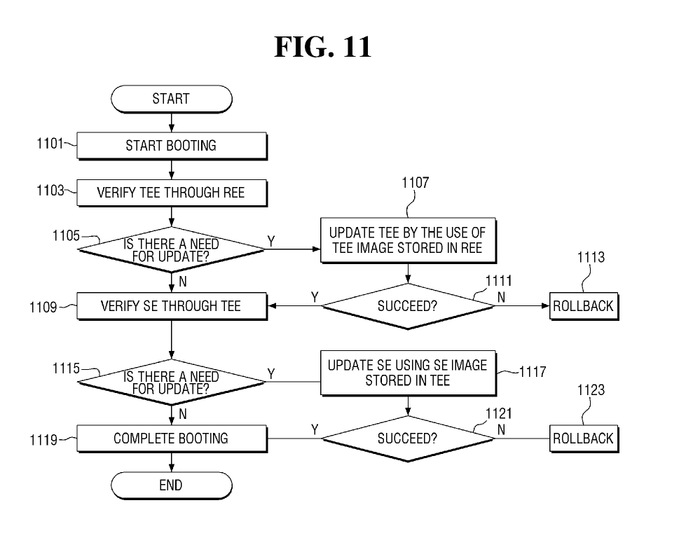

FIG. 11 is a flowchart for explaining a method for updating software according to an embodiment of the present disclosure.

Referring to FIG. 11, a method for updating software according to an embodiment of the present disclosure starts booting of the system 1 for updating software (1101), and verifies the TEE image 310, 410 through the REE (1103). The method, for example, verifies the binary hash or the software version of the TEE image 310, 410 to determine whether there is a need to update the software that drives the TEE (1105).

When there is a need to update the TEE software, the method updates the software for driving the TEE by the use of the TEE image 310, 410 stored in the REE (1107), and determines whether the update is successfully performed (1111). If the update is not successfully performed, the software for driving the TEE is rolled back (1113), and if the update is successfully performed, the SE image is verified through the TEE (1109). When there is no need to update the TEE software as determined in operation (1105), the method proceeds directly from operation (1105) to operation (1109). Upon completing operation (1109), the method, for example, verifies the software version of the SE image to determine whether there is a need to update the software for driving the SE (1115).

When there is a need to update the SE software, the method updates the software for driving the SE by the use of the SE image stored in the TEE (1117), and determines whether the update is successfully performed (1121). If the update is not successfully performed, the software for driving the TEE is rolled back (1123), and if the update is successfully performed, booting of the system 1 for updating software is completed (1119). When there is no need to update the SE software, as determined in operation (1115), the method transitions directly from operation (1115) to the completion of booting (1119).

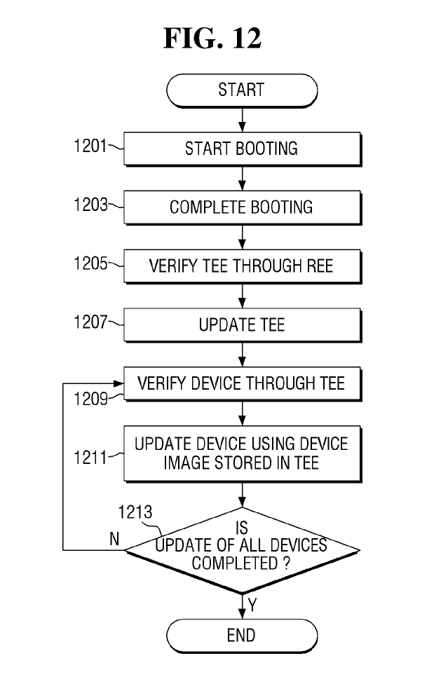

FIG. 12 is a flowchart for explaining a method for updating software according to an embodiment of the present disclosure.

Referring to FIG. 12, in a method for updating software according to another embodiment of the present disclosure, the booting of the system 1 for updating software is started (1201), and after the booting of the system 1 for updating software is completed (1203), the TEE image 310, 410 is verified through the REE (1205). When there is a need to update the TEE software, the method updates the software for driving the TEE using the TEE image 310, 410 stored in the REE (1207).

Next, the method verifies the device image through the TEE (1209). The method, for example, verifies the software version of the device image to determine whether there is a need to update the software for driving the device 230, 232. When there is a need to update the device software, the method updates the software for driving the device 230, 232 by the use of the device image stored in the TEE (1211), and determines whether the verification and update of all the devices are completed (1213). If a device image required for verification and updating is still present, the device image is verified through the TEE (1209).

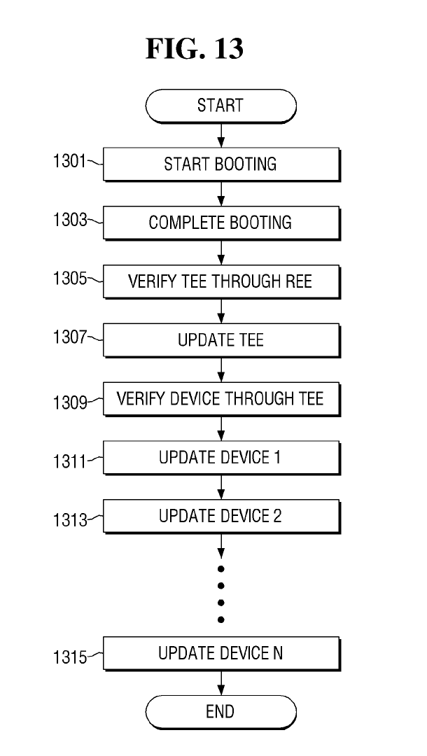

FIG. 13 is a flowchart for explaining a method for updating software according to an embodiment of the present disclosure.

Referring to FIG. 13, in a method for updating software according to still another embodiment of the present disclosure, booting of the system 1 for updating software is started (1301), and after the booting of the system 1 for updating software is completed (1303), the TEE image 310, 410 is verified through the REE (1305). When there is a need to update the TEE software, the method updates the software for driving the TEE by the use of the TEE image 310, 410 stored in the REE (1307).

Next, the method verifies the first device image through the TEE (1309). The method, for example, verifies the software version of the first device image to determine whether there is a need to update the software for driving the first device 230. When there is a need to update the software of the first device 230, the method updates the software for driving the first device 230 by the use of the first device image stored in the TEE (1311).

Next, the method, for example, verifies the software version of the second device image to determine whether there is a need to update the software for driving the second device 232. When there is a need to update the software of the second device 232, the method updates the software for driving the second device 232, by the use of the second device image stored in the first device 230 (1313). Such processes are repeated to complete the updating up to the N-th device (where, N is a natural number) (1315).

Various embodiments of the present disclosure as described above can be embodied as program instructions capable of being performed through various computers, and can be recorded in a computer-readable recording medium. Here, the recording medium can include program instructions, data files, data structures or the like. The program instructions may be specially designed and configured for various embodiments of the disclosure or may be well known to those skilled in the field of computer software and available. Further, the recording medium can include a magnetic media such as a hard disk, a floppy disk and a magnetic tape, an optical media such as a CD-ROM and a DVD, a magneto-optical media such as a floptical disk, a ROM, a RAM, and hardware such as a flash memory. Further, the program instructions may include a high-level language code capable of being executed by a computer by the use of an interpreter or the like, as well as of a machine language code such as being produced by a compiler.

Meanwhile, various embodiments of the present disclosure as described above may be embodied as a hardware module that is electrically connected to the processor 10 and operates based on the control of the processor 10. For example, the various embodiments of the present disclosure as described above may be manufactured so as to form a plurality of semiconductor elements in a partial region of the application processor.

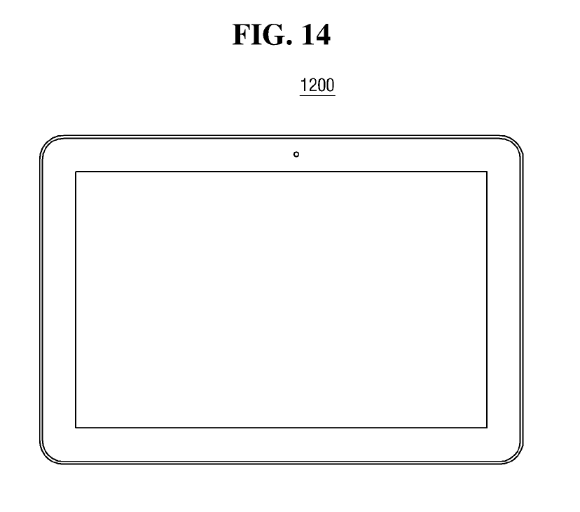

FIGS. 14 to 16 are exemplary semiconductor systems to which the method and system for updating software according to the embodiments of the present disclosure are applicable.

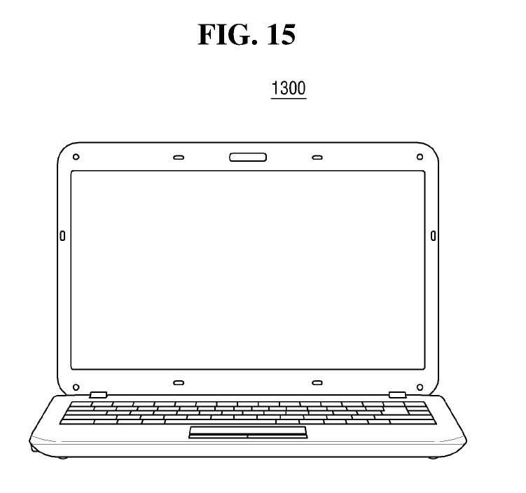

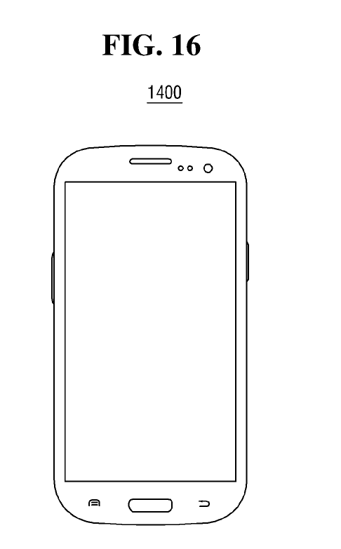

FIG. 14 is a diagram illustrating a tablet PC 1200, FIG. 15 is a diagram illustrating a notebook computer 1300, and FIG. 16 illustrates a smart phone 1400. At least one of the method and system for updating software according to the embodiments of the present disclosure can be used for the tablet PC 1200, the notebook computer 1300, the smart phone 1400 or the like.

Further, it is obvious to those skilled in the art that the method and system for updating software according to some embodiments of the present disclosure are also applicable to other integrated circuit devices that are not illustrated. That is, although only the tablet PC 1200, the notebook computer 1300 and the smart phone 1400 have been described above as an example of the system for updating software according to the present embodiment, the example of the system for updating software according to the present embodiment is not limited thereto. In some embodiments of the present disclosure, the system for updating software may be embodied as a computer, an ultra mobile PC (UMPC), a workstation, a net-book, personal digital assistants (PDA), a portable computer, a wireless phone, a mobile phone, an e-book, a portable multimedia player (PMP), a portable game machine, a navigation device, a black box, a digital camera, a 3-dimensional television, a digital audio recorder, a digital audio player, a digital picture recorder, a digital picture player, a digital video recorder, a digital video player or the like.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

1. A method for updating software, the method comprising:
verifying, with a processor and a first update manager that operates in a non-security execution environment, an update for first software that drives a security execution environment in the non-security execution environment;
updating, with the first update manager, the first software by use of a first image of the first software update, which is stored in the non-security execution environment;
verifying, with the processor and a second update manager that operates in the security execution environment, an update for second software that drives a security device controlled by the security execution environment, in the security execution environment; and
updating, with the second update manager, the second software by use of a second image of the second software update, which is stored in the security execution environment, wherein
verifying the updates for the first and second software includes verifying the correct software versions or capabilities of the first and second software updates.

2. The method of claim 1, further comprising storing, with an image manager, the second image and the first image in the non-security execution environment, prior to verifying the first software update.

3. The method of claim 2, wherein the second image is encoded when it is stored in the non-security execution environment.

4. The method of claim 3, further comprising:
receiving, by the second update manager, the encoded second image from the non-security execution environment to store the encoded second image in the security execution environment, wherein
updating the second software by the use of the second image of the second software update stored in the security execution environment comprises, after decoding the encoded second image, updating the second software by use of the decoded second image.

5. The method of claim 1, wherein verifying the first software update comprises verifying at least one of a binary hash and software version information of the security execution environment.

6. The method of claim 1, wherein verifying the second software update comprises verifying software version information of the security device.

7. The method of claim 1, wherein the first software includes firmware or an application, and the second software includes firmware or an application.

8. The method of claim 1, wherein updating the first software by the use of the first image of the first software update further comprises backing-up a current image of the first software in the security execution environment, prior to updating the first software.

9. The method of claim 1, wherein updating the second software by the use of the second image of the second software update further comprises backing-up a current image of the second software in the security execution environment or the security device, prior to updating the second software.

10. The method of claim 9, wherein updating the second software by the use of the second image of the second software update further comprises rolling back the second software by use of the current image of the second software backed up in the security execution environment or the security device, when the update of the second software fails.

11. The method of claim 1, wherein:
the security device comprises a first security device and a second security device different from the first security device,
verifying the second software update comprises verifying updates for third software and fourth software that respectively drive the first security device and the second security device, and
updating the second software further comprises updating the third software and the fourth software, by respective use of a third image of the third software update and a fourth image of the fourth software update that are stored in the security execution environment.

12. The method of claim 11, further comprising storing, with an image manager, the third image, the fourth image, and the first image in the non-security execution environment, prior to verifying the first software update.

13. (canceled)

14. A method for updating software, the method comprising:
storing, with an image manager, image data in a non-security execution environment, the image data including a first image of an update for first software that drives a security execution environment, and a second image of an update for second software that drives a security device controlled by the security execution environment;
updating, with a first update manager that operates in the non-security execution environment, the first software in the non-security execution environment by use of the first image of the image data;
extracting the second image included in the image data to store, with the image manager, the second image in the security execution environment; and
updating, with a second update manager that operates in the security execution environment, the second software in the security execution environment by use of the second image stored in the security execution environment.

15. The method of claim 14, wherein:
the first image is a non-encoded image and the second image is an encoded image, and
the encoded second image is decoded only in the security execution environment and is not decoded in the non-security execution environment.

16-17. (canceled)

18. The method of claim 14, wherein:
the security device comprises a first security device and a second security device different from first security device,
the image data stored in the non-security execution environment comprises a third image of an update for third software and a fourth image of an update for fourth software that respectively drive the first security device and the second security device,
extracting the second image included in the image data to store, with the image manager, the second image in the security execution environment comprises extracting the third image and the fourth image included in the image data, and
updating the second software in the security execution environment by the use of the second image stored in the security execution environment comprises updating the third software and the fourth software by use of the third image and the fourth image.

19-20. (canceled)

21. The method of claim 14, wherein:
the image data further comprises a first signature associated with the first software update and a second signature associated with the second software update,
updating the first software in the non-security execution environment by the use of the first image of the image data comprises updating the first software by the use of the first image after verifying the first signature, and
updating the second software in the security execution environment by the use of the second image stored in the security execution environment comprises updating the second software by the use of the second image stored in the security execution environment after verifying the second signature.

22-26. (canceled)

27. A system for updating software, the system comprising:
a processor;
a first update manager that operates in a non-security execution environment; and
a second update manager which operates in a security execution environment, wherein:
the first update manager verifies an update for first software that drives the security execution environment by use of the processor and updates the first software by use of a first image of the first software update stored in the non-secure execution environment, and
the second update manager verifies an update for second software that drives a security device controlled by the security execution environment by use of the processor and updates the second software by use of a second image of the second software update stored in the security execution environment, wherein
verifying the updates for the first and second software includes verifying the correct software versions or capabilities of the first and second software updates.

28. The system of claim 27, further comprising an image manager that stores the second image and the first image in the non-security execution environment, before verifying the first software update.

29. The system of claim 28, wherein:
the second image is encoded and the first image is not encoded, and
the image manager stores the encoded second image and the non-encoded first image in the non-security execution environment.

30. The system of claim 29, wherein:
the second update manager receives the encoded second image from the non-security execution environment to store the encoded second image in the security execution environment, and
after decoding the encoded second image, the second update manager updates the second software by use of the decoded second image.

31-33. (canceled)
